(19) United States
(12) Patent Application Publication
(10) Pub. No.: US 2007/0035400 A1
(43) Pub. Date: Feb. 15, 2007

(54) Method for displaying a reference relating to protective rights which protect a product

(75) Inventor: Eric Lauper, Bern (CH)

Correspondence Address: PEARNE & GORDON LLP, 1801 EAST 9TH STREET, SUITE 1200, CLEVELAND, OH, 44114-3108, US

(73) Assignee: Swisscom Mobile AG, Bern (CH)

(21) Appl. No.: 11/586,474

(22) Filed: Oct. 25, 2006

Related U.S. Application Data
(63) Continuation of application No. PCT/EP05/51789, filed on Apr. 21, 2005.

(30) Foreign Application Priority Data
Apr. 26, 2004 (EP) 04101729

(51) Int. Cl. G08B 13/14; H04Q 7/20

(52) U.S. Cl. 340/572.1; 235/492; 455/433

(57) ABSTRACT

A method is disclosed for displaying on a product (1) a reference (30) relating to protective rights that protect a product (1). According to the method, an RFID element (10) is linked to a product (1) and the RFID element (10) contains data on the basis of which at least one protective right indication (30) can be determined. The protective right indication (30) can be downloaded from a remote server (7) over a telecommunication network. The invention also relates to a system having at least one server (7) where protective right indications (30) are stored that correspond to said products (1) and to a database system where one or several protective right indications (30) are stored corresponding to said products (1) and to a database system where one or several protective right indications (30) are linked to at least some of said codes.

### REFERENCE DATA

This application is a continuation of International Patent Application of PCT/EP2005/051789 (WO2005103969) filed on Apr. 21, 2005 claiming Convention priority of European application 2004EP-101729 (EP1591937) filed Apr. 26, 2004, the contents whereof are hereby incorporated by reference.

### TECHNICAL FIELD

The present invention concerns a method and a system with which a reference to protective rights that protect a product can be apposed on a product.

### STATE OF THE ART

For most intellectual property rights, it is possible to appose a reference relating to protective rights. For trademarks, the indications ® and ™ have become established. For patent rights, depending on the country where the patent was filed or granted, it is possible to mark a product with an indication such as “patent pending”, “patent EPXXX,XXX” or, in Switzerland, with the Federal cross and the patent number.

The reason of the reference is among others to draw the attention of third parties to the fact that a product is protected by one or several protective rights. Furthermore, such a reference is a condition in several countries for the owner of the protective right to claim the maximum compensation provided.

However, a wrong indication (for example an indication to a protective right that does not exist or no longer exists in a particular country) is not allowed or is even punishable in many countries. The product manufacturer must therefore pay particular care that no product with a protective right indication is commercialized in a non-protected country. This causes nearly insolvable logistics problems, especially in the case of products that are distributed over several channels and distributors. Furthermore, the indication has to be modified as soon as the status of a protective right title changes in a country. After grant of a patent in a certain country, the indication “Patent Pending” must be replaced by “Patent”; after expiry of the patent, this indication is then no longer allowed.

In order to solve these problems, some product manufacturers appose on their products an exhaustive list of the protective right titles concerned for each country. For small products (for example electronic components or portable products), the space available is not sufficient for a detailed indication. Furthermore, the list would always have to be updated at each change of the protective rights portfolio.

Publications containing RFID elements, from which however no reference to a protective right indication emerges, are for example US-A1-2003/0155413, US-A1-2002/0174025, WO-A2-03/067396, US-A1-2002/0143643.

US-A1-2003/0155413 describes a system that is capable of reading labels provided on physical objects. It is possible in a first mode (authoring mode) to connect audio data, text messages, graphics or video messages with these labels. In a second mode (playback mode), the messages linked with the object are played. This can occur through a server in which a collection of multimedia information is stored. Since the link between the label and the object can be designed at his own discretion by the user, no secure product indication is possible with this system.

US-A1-2002/0174025 concerns a method for making shopping easier. Products are provided with RFID tags and are read during the purchase. This allows for shopping that corresponds to the needs of the customers, who are provided with a shopping card. Preferred information is collected in a central unit and advertisements and personalized information is displayed from time to time to the user.

WO-A2-03/067396 discloses a system wherein products are provided with a RFID tag. The labels reproduce location information of a series of bundled products (pallets, warehouses). An individual product indication through RFID does not arise from this document.

### REPRESENTATION OF THE INVENTION

It is an aim of the present invention to propose a new method for solving these problems with indications relating to protection right titles.

This aim is achieved among others through a method for apposing on a product a reference to protective rights that protect a product, wherein a RFID element is linked with the product, the RFID element containing data on the basis of which at least one protective right indication can be determined.

This has the advantage that the protected product is marked only with one RFID element from which a detailed indication can be determined. RFID elements can be tiny and manufactured cheaply and are in any case apposed to an increasing number of products for other purposes, for example to guarantee traceability.

In one embodiment, the RFID element includes a code on the basis of which the protective right indication can be determined from a server in a remote (i.e. not local) telecommunication network. This has the advantage that the indication is not stored in the RFID element but in a remote server. The memory space in a server is considerably cheaper and faster than in a RFID element. Furthermore, the indication can be edited and updated at any time without having to access the RFID elements.

In one embodiment, said code is transmitted to a name service server in which links between several electronic codes and several electronic addresses of pages are recorded. The protective right indication is then downloaded from the page stored at the address corresponding to said code. This has the advantage that the protective right indication is thus stored on a page and that the address of the page can be changed at any time without having to adapt all the RFID elements.

This also has the advantage that the indication can be of any length without influencing the price or the size of the RFID element attached to the product.

The address of the page corresponds to the code read in the RFID element. The link between the code and the electronic address of the page is not static but is recorded in a name service server. This has the advantage that changes off the page address are possible at any time and are easily traceable.

### BRIEF DESCRIPTION OF THE FIGURES

The present invention will be described hereinafter in more detail on the basis of the figures, which show:

FIG. 1 a block diagram of a system with a mobile device, a RFID reader device, a RFID element, a name service server and a page server, and

FIG. 2 a block diagram of a system with a mobile device, a RFID reader device and a RFID element.

### WAYS OF EXECUTING THE INVENTION

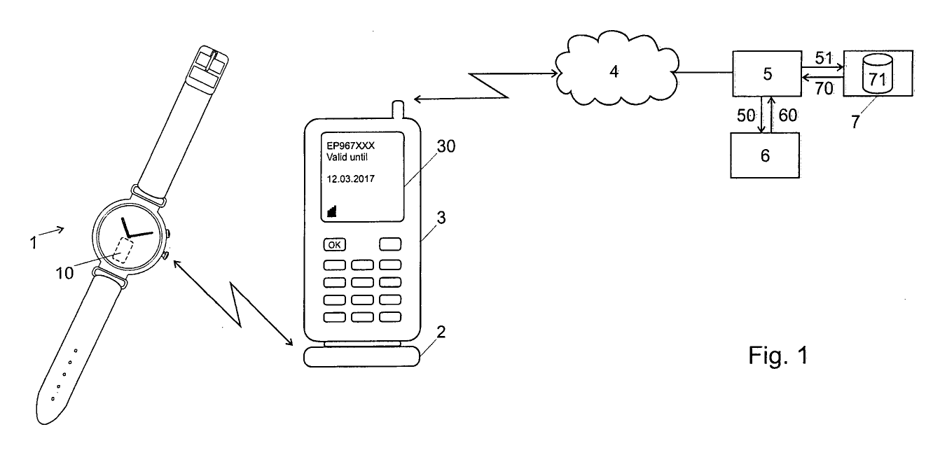

FIG. 1 shows a system that is used by the user or mobile subscriber to receive with the inventive method protective right indications 30 about a protected product 1 (in this case a watch). A mobile device 3 (for example a mobile radio telephone or a PDA with an interface for a cellular mobile radio network) can receive from a mobile radio network 4 and send to this network short messages (for example SMS and USSD) and data (for example IP packets). The mobile radio network 4 is for example a GSM, GPRS, HSCSD, EDGE, UMTS or CDMA network over which also data can be transmitted. Instead of a mobile radio network 4, the inventive method can also be performed analogously with a fixed network, for example a fixed line telephone network, a Powerline network or a cable TV network. The mobile device 3 includes an identification module (for example a SIM card 30) to identify the device through the network 4. One or several software applications can be executed by a processor in the mobile device 3 and/or in the SIM card 30.

The mobile device 3 further comprises a RFID reader device 2 or is connected with such a reader part (for example over a USB, Firewire, PCCard, CompactFlash, proprietary etc. connection or over a Bluetooth or WLAN contactless connection). The reader part includes a microcontroller and least one antenna or coil for exchanging data with RFID components in the immediate vicinity. The data transmission occurs preferably in the frequency range of 13.56 Mhz, 900 Mhz and/or 860-930 Mhz. The reader part can preferably be chosen to work in different frequency ranges and with different RFIDs. The operational range for reading the RFID is preferably between 2 and 10 meters—depending on the orientation of the reader part and of the element. The connection preferably occurs in half-duplex mode with an ASK backscatter modulation.

The product 1 includes a RFID element 10 with a non-erasable permanent memory area in which a code is stored during manufacture or during personalization. The code preferably identifies univocally each particular RFID element 10; each RFID element 10 preferably has another individual code. It is however also conceivable that the code designates only the type of the product 1. The code preferably cannot be falsified.

The codes preferably include 64, 96 or more bits and are organized hierarchically. The answer of the RFID element 10 to a query of the reader device 2 preferably includes a header, redundant verification data and the code. Other data can be stored in the memory area of the chip 10 and be read by the reader part.

Codes are preferably distributed by a common authority to different product manufacturers; part of the code preferably indicates the identity of the manufacturer of the product 1. A manufacturer wishing to mark products 1 with protective right indications 30 reserves a series of codes from the common authority and stores part of these codes in RFID elements 10.

At least one application is provided in the mobile device 3 for reading codes in neighboring RFID elements 10 over the reader device 2 and for sending this code over the mobile radio network 4. Reading a code is preferably initiated by the mobile device 3; it is possible for example that the mobile device continuously or periodically searches for neighboring RFID elements 10 and reads, processes or forwards the codes in found RFID elements 10. In another, low-current embodiment, reading is initiated by the user of the mobile device 3 that launches a corresponding application or enters a command if he wishes to read a protective right indication 30 about a particular product 1. This step can possibly be required in order to be able to use the product 1 at all; in one embodiment, before displaying the indication 10, the product 1 can be blocked and unblocked only after reading the code with a command from a remote server.

Reading the RFID elements 10 with the mobile device 3 or with another device can also be initiated by an external device (for example a selling point or an automatic machine) over an interface at close range (for example Bluetooth or WLAN) over the mobile radio network 4 or over a link on a visited WEB or WAP page.

Simple filters and processing means can be provided as part of the application in the mobile device 3 and/or in the reader part, in order to process read codes. The application can for example process and forward only certain code parts. Redundancy checks can also be provided to delete codes that are not plausible or that contain errors. Previously used codes are preferably stored in a database in the mobile device 3 for the purpose of future controls, statistic evaluations and backups.

According to the application, a password or another authentication can also be requested before the code is read or forwarded. The password can for example be printed on a hidden part of the value card that can be uncovered, or is communicated to the mobile user over another channel.

An application in the mobile device 3 can request a confirmation of the user before the code is processed any further and the desired protective right indication 30 is reproduced. This confirmation can for example be entered over the keyboard of the mobile device, of the PDA, over other input means or with a voice command.

If the password is correct and the confirmation is received, the read code is packaged by the application in a message (for example in a short message or preferably in a GPRS or UMTS packet) and sent over the mobile radio network 4 to a server 5 at a known address, preferably a server within the infrastructure of the mobile radio network 4. The message is optionally signed and/or provided with a time stamp by the mobile device 3 or by the SIM card.

The server 5 administers messages with codes that are received from several or possibly all RFID readers 2 of the mobile devices 3. Other, more complex filters can be provided in the server 5 in order to handle codes from different areas differently or not at all.

The server 5 can also verify the identity of the user. This is all the more reliable if the server 5 is administered by the operator of the mobile radio network 4. In this case, the identity of the mobile user can be determined reliably for example on the basis of the IMSI (International Mobile Subscriber Identity) or of another identity in the SIM card. In this manner, user-dependent protective right indications 30 can be reproduced, for example indications that depend on the user's profile and preferences.

The server 5 is connected over Internet or an intranet with a name service server 6 in which for each code a corresponding electronic address of an electronic page is stored.

A query 50 with the code just received is directed by the server 5 to the name service server 6, which answers with the corresponding electronic address (answer 60). The electronic address consists for example of an URL or another address for a TCP-IP network.

The name service server 6 can be administered by the operator of the server 5 and/or by external entities (for example by the organization distributing the codes to the different companies). Several name service servers can be connected with one another so that the desired address is sought in another name service server if it is not found in the server 6. This allows for example a mobile radio network operator to process also codes from other organizations.

The user of the mobile device 3 can thus always direct all codes of all product manufacturers to the same target server 5, which determines from the name service server 6 or from the network of name service servers 6 the address of the page on the basis of which the desired protective right indication can be downloaded.

The connection in the name service server 6 between a code and an address can preferably be modified anytime by the provider of the desired service (for example over a dedicated WEB form). This allows the electronic address of a page or of a domain to change without having to inform the end users.

The address of the page on which the protective right indication is located can thus be found only and univocally on the basis of the 64 or 96 bits codes stored in the RFID element 10; the page that is accessed is thus completely independent from the address or telephone number of the server 5. Since many products 1 must be marked, and since for security reasons not all codes can be used, enough freely available bits must be provided for the codes; simple IP numbers for example would possibly not suffice since very many possible combinations have already been allocated. Another, independent page addressing system is preferably used.

The server 5 receives the answer 60 from the name service server 6 with the desired page address and accesses the corresponding page in the server 7 or a network with several local or remote servers (query 51 and answer 70).

In one embodiment, the address of the desired page results from a combination of the address indicated by the name service server 6 with one or several bits of the code. In this case, the address in the name service server 6 corresponds to an area in which the individual pages correspond to certain parts of the code. This has the advantage that the name service server 6 can be designed more easily.

The page in the server 7 that is accessed by the server 5 possibly includes a hypertext content in a markup language. In one embodiment, this page comprises an XML (extended Markup Language) content. In another embodiment, the page includes a PML (Product Marking Language) content. The page can also support SOAP protocol (Simple Object Access Protocol), .NET Framework or other web services with which the server 5 and finally the mobile device 3 can access the services and objects of the server 7, from which the desired protective right indications 30 can be determined.

The server 5 downloads the desired page or part of the page from the server 7 and transmits it further to the mobile device 3. As will be described later, the page on the server 7 can also include a multimedia content in order for example to reproduce protective right indications 30 also acoustically or with images. It is also possible that the protective right indication is spread over several pages that can be connected to one another with links so that the user can download more information about a protective right indication by clicking or selecting links or menu options.

The protective right indication can depend on parameters determined within the mobile radio network 4 and/or the mobile device 3, including the identity of the user of the mobile device 3, his type of contract, his location, the time, the visited network, his profile etc. The language of the determined content can depend on the mobile user's location and/or on his previously stored profile.

The desired protective right indication can be transmitted to the mobile device 3 and/or to the SIM card over a reverse channel, for example as a message (SMS, MMS, USSD or e-mail) or as WEB or WAP page. In one embodiment, the indication is reproduced acoustically, for example by a loudspeaker or headphones of the mobile device 3. In this case, an audio file can be stored in the server 7 or be generated by a voice synthesizer.

The reference can be communicated to the user also within a session with several user queries and corresponding answers. In one embodiment, a declaration is stored in the server 5 or 7 that the protective right indication has been sent to the user in order to be able to also prove this later. This declaration can be signed electronically and be provided with a time stamp.

The following protective right indications are stored on the page in the server 7 and transmitted to the mobile device 3:
at least one reference relating to one or several patents, patent applications or utility model that concern the technical features of the product 1, and/or
at least one reference relating to one or several trademarks designating the product 1, and/or
at least one reference relating to one or several designs respectively ornamental designs that concern the aesthetic features of the product 1, and/or
at least one reference relating to one or several protected semiconductor topographies, and/or
at least one reference to a copyright protection, and/or
General Business Terms of the product manufacturer.

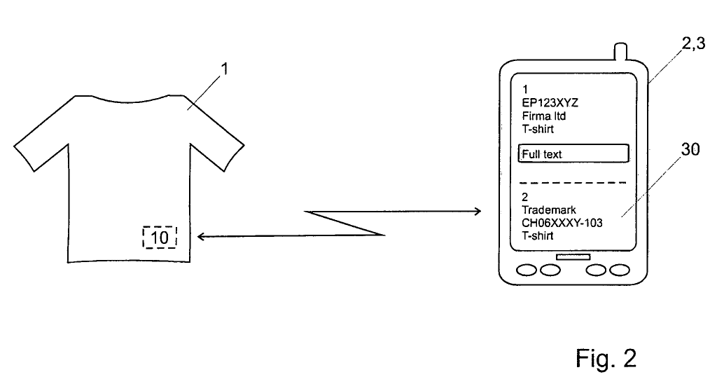

As can be seen from FIG. 2, the protective right indication can include a list of several protective rights relating to the product 1, for example a list of patent numbers, trademark numbers, etc. with which the product 1 is presumed to be protected. More information about a particular protective right can be displayed by selecting a particular protective right from the list of protective right indications 30. For a patent or design, for example, the complete document can be downloaded in image format, for example in .tif or .pdf format, by selecting a patent resp. design number in the list. For a visual trademark, an image of the mark can for example be displayed.

It is also possible that the reference stores an abstract of the protective right, bibliographic data or the legal status of the protective right in such a manner in the server 7 that the user receives this information directly or by selecting the relevant protective right.

In one embodiment, the page in the server 7 includes a content that is generated dynamically from a protective rights' database 71. Web protective rights' databases as such are already known and are offered by different firms and organizations among others under the addresses www.propis.com, www.espacenet.com or www.depatisnet.dpma.de. According to the invention, a direct access to the page with the protective right or with the list of protective rights relating to the product 1 is ensured on the basis of the code in the RFID element 10 in the product 1, so that a user by reading the RFID element 10 for example directly reaches the page in Espacenet that contains the appropriate patent or the list of appropriate patents.

In one embodiment, the location of the mobile device 3 is determined on the basis of a satellite location determining module or in the telecommunication network, for example on the basis of the identity of the mobile radio network 4 or by triangulation between several base stations. The location information can be used by the mobile device 3 or by one of the servers 5 or 7 to adapt the list of protective right indications that extend also to the State where he is located. It is thus also possible to adjust the language of the reference or national legal conditions depending on the user's location.

A profile of the user can be stored in the server 5 or 7 or, for example as cookie, in the mobile device 3, and the protective right indication is adapted to it. This allows for example a personal adaptation of the reference's language to the user.

In a preferred embodiment, each RFID element 10 bears a different code with which each product 1 is designated individually. Several same products of the same model thus have a different code (for example a different serial number). This allows the protective right indication to be adapted to each individual product, in order for example to take into account individual adaptations or by taking into account in the protective right indication indications relating to licenses that have been acquired or that are to be acquired for the individual product. In this case, an individual, user-dependent protective right indication can be displayed, for example “this product has been protected in the State XY where you are located through patent EPXYZ12345; an exclusive user license was acquired on 15 Apr. 2004 for the personal use of the user XY”. In one embodiment, the page on the server 7 offers the possibility to acquire, extend, or adapt for other use purposes a license, where the license fee can preferably be paid also directly with the mobile device 3. The license conditions can preferably depend on the user, the location and the product 1.

In one embodiment, the product 1 consists of a data carrier with a protected content, for example of a magnetic and/or optical data carrier, in which music, texts, images, films, games, software applications and/or other works are stored that are protected by a protective right (for example copyright) and for which a license can be acquired. The protective right indication can be determined and displayed by the device in which said data carrier has been loaded or by another separate device. The releasing of the license can possibly be subjected to certain conditions, for example that the user produces a valid code from the RFID element 10 or that he has been identified.

In one embodiment, use of the product 1 is blocked as long as the related protective right indications have not been transmitted to the mobile device 3 and/or as long as no appropriate license has been acquired. The product 1 is unblocked after the exchange with the server 5, 7, by modifying data (for example a blocking flag) in the server 7 and/or in a memory area of the product 1. In one embodiment, data are also written by the RIFD reader device 2 in the RFID element 10 after a change in the licensing status has occurred. This allows the licensing status of the product 1 to be checked without connection with the server 7.

FIG. 2 shows a further embodiment in which the protective right indication is read by a RFID reader device 2 of the mobile device 3 and displayed immediately afterwards without the reference having to be downloaded from a remote server. In this case, all the indications are read directly from the RFID element 10.

### REFERENCE LIST

1 Product
10 RFID element
2 EFID reader device
3 Mobile device
30 Protective right indication
4 Mobile radio network
5 Server
50 Query
51 Query
6 Name service-server
61 Answer
7 Server
70 Answer
71 Protective rights' database

1. Method for disclosing a reference to protective rights that protect a product, with the following method steps:
an RFID element is linked with the product, with the RFID element containing data on the basis of which at least one protective right indication relating to said product can be determined with a RFID reader device connected with a user's mobile device, and with at least one part of the protective right indication in said RFID element being stored or said data including a code and said protective right indication being determined on the basis of said code from a server in a telecommunication network, and
the mobile device then reproduces to the user the determined protective right indications.

2. The method of claim 1, wherein said code is transmitted to a name service server in which links between several electronic codes and several electronic addresses of pages in said telecommunication network are recorded, and
wherein said protective right indication is downloaded from the page stored at the address corresponding to said code.

3. The method of claim 1, wherein said data a read in the RFID element with the RFID reader device,
the RFID reader device being connected with the mobile device or being built as part of the mobile device,
said mobile device being connected to a remote telecommunication network,
and said protective right indication being downloaded from said remote telecommunication network.

4. The method of claim 1, wherein said protective right indication is reproduced by said mobile device visually and/or acoustically.

5. The method of claim 1, wherein said protective right indication is transmitted as data message to the mobile device and is displayed on a display of the mobile device.

6. The method of claim 1, wherein said protective right indication is transmitted as WEB and/or WAP page and is reproduced accordingly with a WEB and/or WAP browser by the mobile device.

7. The method of claim 1, wherein said protective right indication is spoken by the mobile device.

8. The method of claim 1, wherein the protective right indication concerns at least one of the following said protective rights:
reference to one or several patents, patent applications or utility model,
reference to one or several trademarks,
reference to one or several designs respectively ornamental designs,
reference to one or several protected semiconductor topographies.

9. The method of claim 1, wherein the protective right indication includes at least one reference to copyright protection.

10. The method of claim 1, wherein the protective right indication includes General Business Terms of the manufacturer of the product.

11. The method of claim 1, wherein the protective right indication includes a list of references to several protective rights applying to the product,
and wherein more information about a particular protective right is displayed when a particular protective right is selected from said list.

12. The method of claim 11, wherein the protective right title is displayed in image format.

13. The method of claim 11, wherein an abstract of the protective right title is displayed.

14. The method of claim 11, wherein the legal status of the protective right is displayed.

15. The method of claim 11, wherein the WEB page is generated dynamically from a database with several protective rights when a particular protective right is selected from said list.

16. The method of claim 1, wherein said protective right indication is location-dependent.

17. The method of claim 1, wherein said protective right indication is adapted depending on a predetermined user profile.

18. The method of claim 1,
wherein said code designates individually each individual product,
and wherein said protective right indication is adapted individually to each product.

19. The method of claim 18, wherein said protective right indication includes indications to licenses that have been acquired or that are to be acquired for said individual product.

20. The method of claim 19, wherein said indications depend on the product, the user and/or the location.

21. The method of claim 1, wherein the user acquires a license for at least one of said protective rights with said mobile device.

22. The method of claim 1, wherein said product is blocked and unblocked when said protective right indications have been determined.

23. The method of claim 21, wherein data are written in said RFID element after a change in the license status has occurred.

24. The method of claim 21, wherein data are transmitted to a server in said telecommunication network after a change in the license status has occurred.

25. The method of claim 2, wherein said server is located within the infrastructure of the telecommunication network,
and wherein said name service server is located outside the infrastructure of the telecommunication network and is accessible to several network operators.

26. System with the following features:
a plurality of products provided with RFID elements in which codes are stored,
at least one server where protective right indications are stored that correspond to said products, these references being stored at an address that can be derived from said codes.

27. The system of claim 26, with a name service server in which links between several electronic codes and several electronic addresses of pages are recorded.

28. The system of claim 26, with a plurality of RFID reader devices that are each connected with a mobile device or are built as part of a mobile device.

29. The system of claim 26, with location determining means for determining the location of the RFID element and for adapting said reference to said location.

30. Database system with the following features:
a plurality of codes that univocally designate the products,
one or several protective right indications linked with at least certain said codes,
an interface for receiving queries from a telecommunication network and for answering these queries with a corresponding protective right indication.
